(19) United States
(12) Patent Application Publication
(10) Pub. No.: US 2025/0056636 A1
(43) Pub. Date: Feb. 13, 2025

(54) MULTI-AP COORDINATION TERMINATION IN WIRELESS NETWORKS

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei (TW)

(21) Appl. No.: 18/789,560

(22) Filed: Jul. 30, 2024

Related U.S. Application Data
(60) Provisional application No. 63/531,271, filed on Aug. 7, 2023.

(51) Int. Cl. H04W 76/15; H04W 76/34

(52) U.S. Cl. CPC H04W 76/15; H04W 76/34

(57) ABSTRACT

A first access point (AP) device in a wireless network is provided. The first AP comprises a memory and a processor coupled to the memory. The first AP establishes multi-AP coordination with a second AP, the multi-AP coordination including a set of agreements established between the first AP and the second AP. The first AP transmits a first frame that requests to terminate one or more agreements established between the first AP and the second AP.

### CROSS-REFERENCE TO RELATED APPLICATIONS

This application claims the benefit of priority from U.S. Provisional Application No. 63/531,271, entitled “MULTI-AP COORDINATION TERMINATION,” filed Aug. 7, 2023, which is incorporated herein by reference in its entirety.

### TECHNICAL FIELD

This disclosure relates generally to a wireless communication system, and more particularly to, for example, but not limited to, target wake time (TWT) operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first access point (AP) in a wireless network. The first AP comprises a memory and a processor coupled to the memory. The processor is configured to cause establishing multi-AP coordination with a second AP. The multi-AP coordination includes a set of agreements established between the first AP and the second AP. The processor configured to cause transmitting, to the second AP, a first frame that requests to terminate one or more agreements established between the first AP and the second AP.

In some embodiments, the processor is further configured to cause receiving, from the second AP, a second frame indicating a response to the first frame, the second frame including a field indicating acceptance, rejection, or alternative suggestion to requested termination of at least one agreement between the first AP and the second AP.

In some embodiments, the first frame or the second frame includes a field indicating if a partial termination of the set of agreements is requested or a full termination of the set of agreements.

In some embodiments, the first frame or the second frame includes a field indicating a type of multi-AP coordination.

In some embodiments, the first frame or the second frame includes a field indicating an identifier of an agreement to be terminated.

In some embodiments, the multi-AP coordination is a target wake time (TWT) based multi-AP coordination.

In some embodiments, when the field indicates that the partial termination is requested, a subset of agreements requested by the first frame or the second frame is terminated.

An aspect of a first access point (AP) in a wireless network. The first AP comprises a memory and a processor coupled to the memory. The processor is configured to cause establishing multi-AP coordination with a second AP. The multi-AP coordination includes a set of agreements established between the first AP and the second AP. The processor is configured to cause receiving, from the second AP, a first frame that requests to terminate one or more agreements established between the first AP and the second AP.

In some embodiments, the processor is further configured to cause transmitting, to the second AP, a second frame indicating a response to the first frame, the second frame including a field indicating acceptance, rejection, or alternative suggestion to requested termination of at least one agreement between the first AP and the second AP.

In some embodiments, the first frame or the second frame includes a field indicating if a partial termination of the set of agreements is requested or a full termination of the set of agreements.

In some embodiments, the first frame or the second frame includes a field indicating a type of multi-AP coordination.

In some embodiments, the first frame or the second frame includes a field indicating an identifier of an agreement to be terminated.

In some embodiments, the multi-AP coordination is a target wake time (TWT) based multi-AP coordination.

In some embodiments, when the field indicates that the partial termination is requested, a subset of agreements requested by the first frame or the second frame is terminated.

An aspect of the disclosure provides a method performed by a first access point (AP) device in a wireless network. The method comprises establishing multi-AP coordination with a second AP. The multi-AP coordination includes a set of agreements established between the first AP and the second AP. The method comprises transmitting, to the second AP, a first frame that requests to terminate one or more agreements established between the first AP and the second AP.

In some embodiments, the method further comprises receiving, from the second AP, a second frame indicating a response to the first frame, the second frame including a field indicating acceptance, rejection, or alternative suggestion to requested termination of at least one agreement between the first AP and the second AP.

In some embodiments, the first frame or the second frame includes a field indicating if a partial termination of the set of agreements is requested or a full termination of the set of agreements.

In some embodiments, the first frame or the second frame includes a field indicating a type of multi-AP coordination.

In some embodiments, the first frame or the second frame includes a field indicating an identifier of an agreement to be terminated.

In some embodiments, when the field indicates that the partial termination is requested, a subset of agreements requested by the first frame or the second frame is terminated.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of individual TWT operation in accordance with an embodiment.

FIG. 5 shows an example of broadcast TWT operation in accordance with an embodiment.

FIG. 6 shows an example of a typical AP development scenario for TWT based multi-AP coordination in accordance with an embodiment.

FIG. 7 shows an example of C-TWT parameter update negotiation in accordance with an embodiment.

FIG. 8 shows an example of a full MAP termination in accordance with an embodiment.

FIG. 9 shows an example of a partial MAP termination in accordance with an embodiment.

FIG. 10 shows an example process of MAP agreement termination in TWT-based MAP coordination in accordance with an embodiment.

FIG. 11 shows another example process of MAP agreement termination in TWT-based MAP coordination in accordance with an embodiment.

FIG. 12 shows another example process of MAP agreement termination in TWT-based MAP coordination in accordance with an embodiment.

FIG. 13 shows an example process of MAP agreement termination among multiple types of MAP coordination in accordance with an embodiment.

FIG. 14 shows an example format of the TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

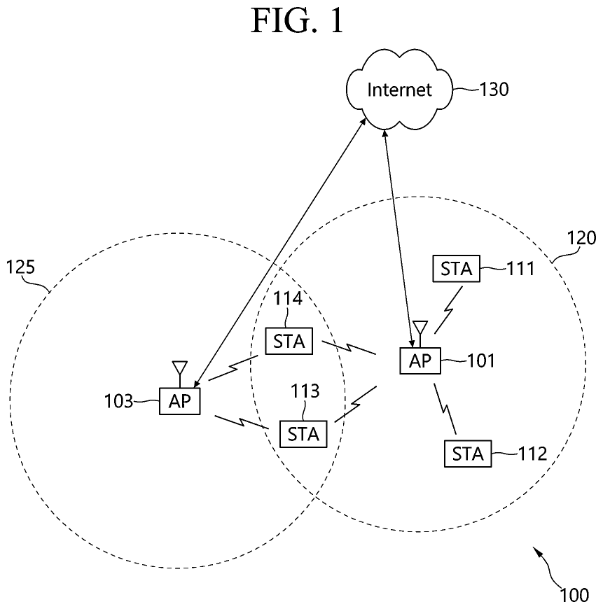

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

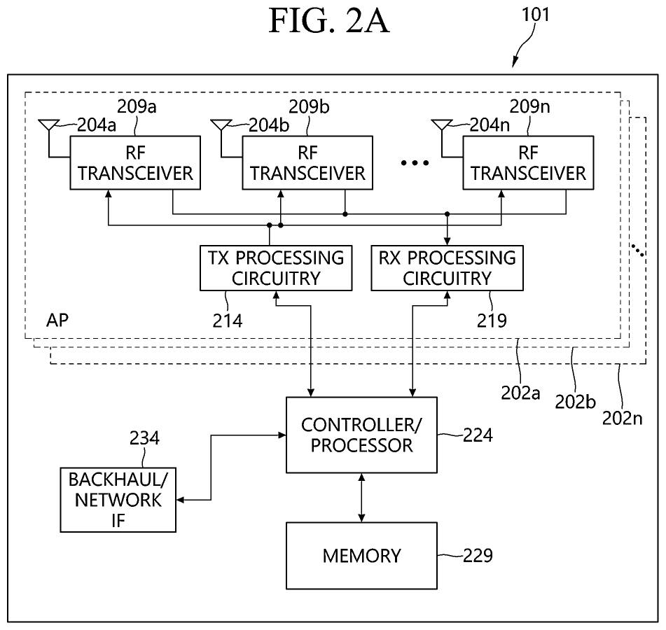

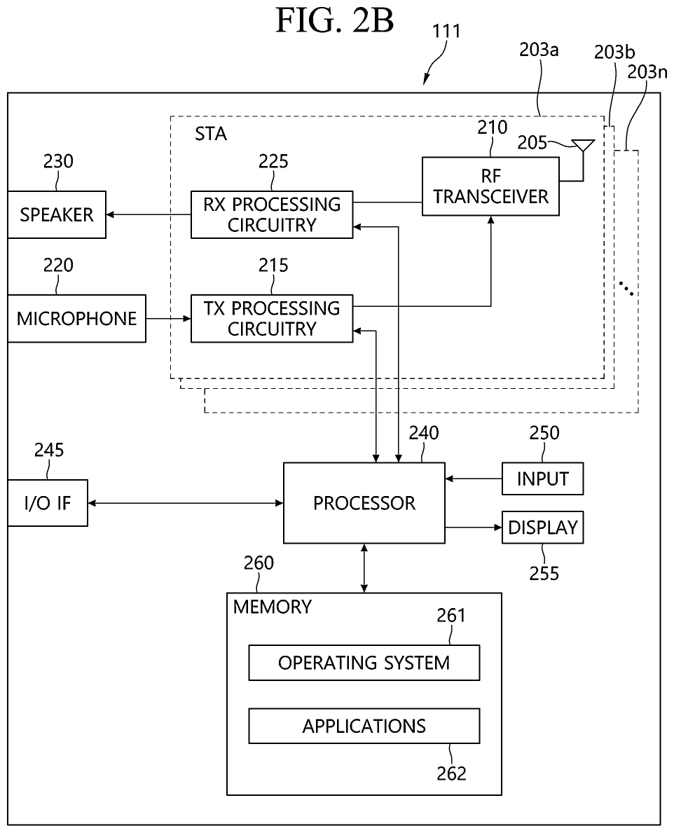

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

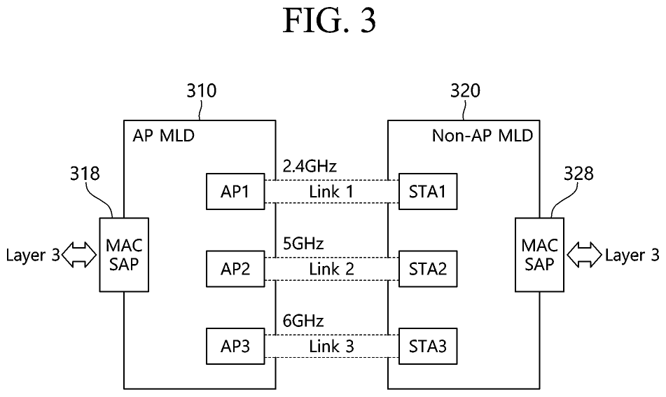

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D3.1, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It may be achieved by allocating STAs to operate at non-overlapping times or frequencies and perform the frame exchange sequences in pre-scheduled service periods. In TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any PPDU (physical layer protocol data unit) format supported by the pair of STAs that have established the corresponding TWT agreement, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

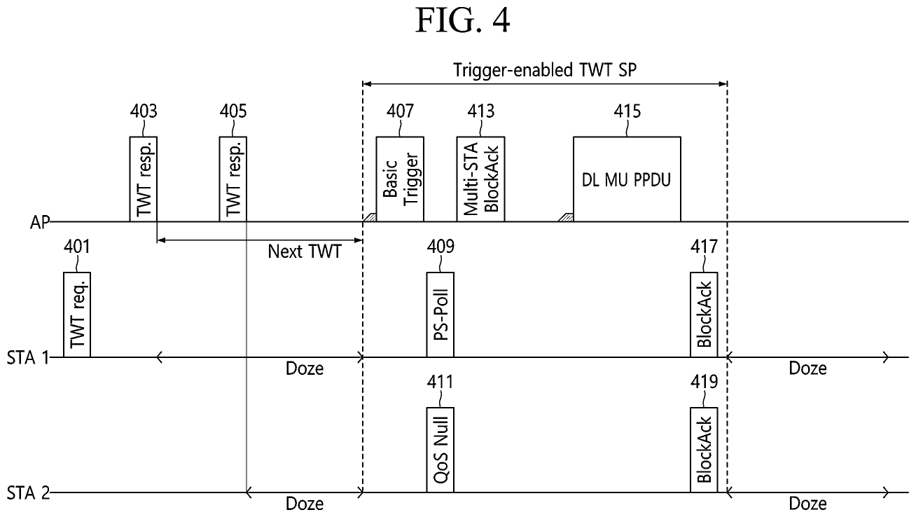

FIG. 4 shows an example of individual TWT operation in accordance with an embodiment. The operation depicted in FIG. 4 is for illustration purposes and does not limit the scope of this disclosure to any particular implementations.

In FIG. 4, STA 1 and STA 2 are TWT requesting STAs, and AP is a TWT responding STA. In the example of FIG. 4, STA 1 sends a TWT request 401 to AP to set up a trigger-enabled TWT agreement. The AP accepts the TWT request 401 with STA 1 and confirms the acceptance in TWT response 403 sent to STA 1. Subsequently, the AP sends an unsolicited TWT response 405 to STA 2 to set up a trigger-enabled TWT agreement with STA 2. Both these TWT agreements are set up as announced TWTs. During the trigger-enabled TWT SP, the AP sends a Basic Trigger frame 407 to the TWT requesting STAs (STA 1 and STA 2) which may indicate that they are awake during the TWT SP. STA 1 indicates that it is awake by sending a PS (power save)-Poll frame 409, and STA 2 indicates that it is awake by sending QoS (quality of service) Null frame 411 in response to the Basic Trigger frame 407. Subsequently, the AP sends a Multi-STA Block Ack 413 frame and DL MU (downlink multi-user) PPDU 415 to both STA 1 and STA 2. Afterward, STA 1 and STA 2 respectively send BlockAck frames 417 and 419 to the AP, and then go to doze state.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

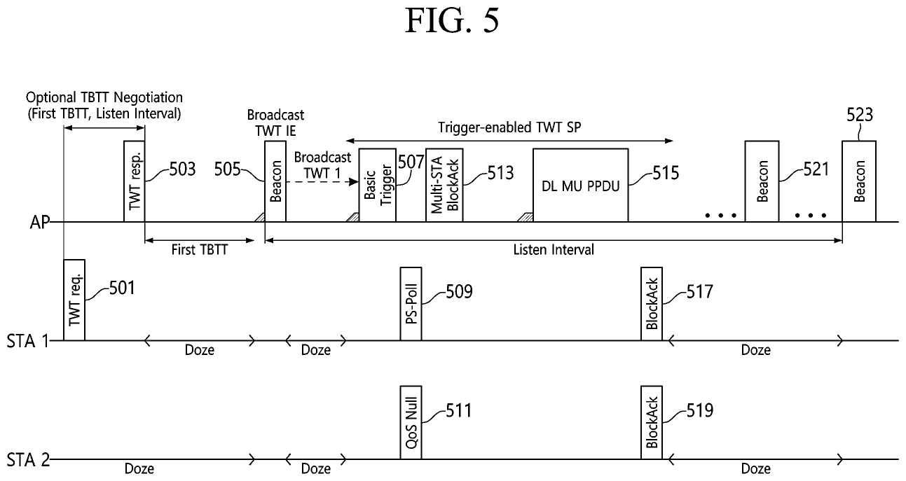

FIG. 5 shows an example of broadcast TWT operation in accordance with an embodiment. The operation depicted in FIG. 5 is for illustration purposes and does not limit the scope of this disclosure to any particular implementations.

In FIG. 5, STA 1 and STA 2 are TWT scheduled STAs, and AP is a TWT scheduling AP. In the example of FIG. 5, STA 1 and AP may have optional TBTT (target beacon transmission time) negotiation by exchanging TWT request frame 501 and TWT response frame 503. After the first TBTT, the AP sends a beacon frame 505 including a broadcast TWT element that indicates a broadcast TWT SP. During the TWT SP, the AP may send trigger frames, or downlink buffer-able units (BUs) to the TWT scheduled STAs (STA 1 and STA 2). STA 1 and STA 2 wake to receive the beacon frame 505 to determine the broadcast TWT. During the trigger-enabled TWT SP, the AP sends a basic trigger frame 507 to STA 1 and STA 2 which indicate that they are awake during the TWT SP. STA 1 indicates that it is awake by sending a PS-Poll frame 509, while STA 2 indicates that it is awake by sending a QoS Null frame 511 in response to the basic trigger frame 507. STA 1 and STA 2 receive their DL BUs in a subsequent frame exchange (e.g., Multi-STA BlockAck 513, DL MU PPDU 515, and BlockAck 517 and 519) with the AP and go to doze state out of the TWT SP. After the TWT SP, the AP sends beacon frames 521 and 523 periodically to STA 1 and STA 2. As illustrated, the AP can advertise/announce and maintain multiple broadcast TWT schedules in the BSS. When a change is made to any of the broadcast TWT schedules, it may affect all STAs that are members of the particular TWT schedule.

TWT enhancements for MLDs have recently been introduced in IEEE 802.11be specification. For individual TWT agreements between two MLDs, a STA affiliated with an MLD, which is a TWT requesting STA, may indicate the link(s) that are requested for setting up TWT agreement(s) in the Link ID Bitmap subfield, if present, of a TWT element in the TWT request. If only one link is indicated in the Link ID Bitmap subfield of the TWT element, a single TWT agreement is requested for the corresponding STA affiliated with the same MLD, which is operating on the indicated link. The Target Wake Time field of the TWT element shall be in reference to the time synchronization function (TSF) time of the link indicated by the TWT element. A TWT responding STA affiliated with a peer MLD that receives a TWT request that contains a Link ID Bitmap subfield in a TWT element responds with a TWT response that indicates the link(s) in the Link ID Bitmap field of a TWT element. The link(s), if present, in the TWT element carried in the TWT response, may be the same as the link(s) indicated in the TWT element of the soliciting TWT request.

Restricted TWT (R-TWT) operation is another important feature for the next generation WLAN. The R-TWT operation provides better support for latency sensitive applications. For instance, traffic in real time applications has stringent requirements in terms of latency and its jitter along with certain reliability constraint. Such traffic may be referred to as latency sensitive traffic in this disclosure. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide greater channel access opportunities to R-TWT member STAs than non-member STAs, thereby improving the flow of latency sensitive traffic.

Interference from one BSS may often lead to performance issues for STAs and APs in neighboring BSSs. This interference may result in overall throughput degradation in the network. The Overlapping BSS (OBSS) interference may also increase the overall latency since it takes more time to access the channel due to the interference occupying the channel. If a STA in a BSS has latency-sensitive traffic, this delay in channel access may significantly impede the performance of the STA's latency-sensitive applications. To address these issues, a TWT-based multi-AP (MAP) coordination is being considered for the next generation WLAN system.

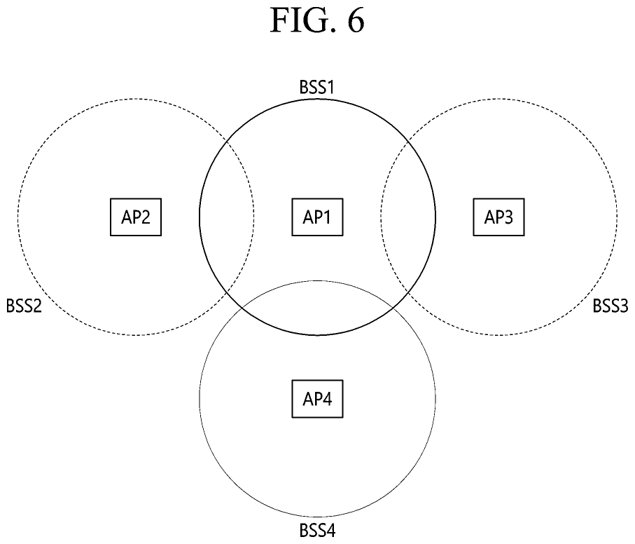

FIG. 6 shows an example of a typical AP development scenario for TWT-based multi-AP coordination in accordance with an embodiment.

In FIG. 6, AP 1, AP 2, AP 3, and AP 4 form BSS 1, BSS2, BSS 3, and BSS4, respectively. In some embodiments, AP 1, AP 2, AP 3, and AP 4 may be members of an TWT coordination AP set and are participating in the TWT-based multi-AP (MAP) coordination. As shown, BSS 1 overlaps with BSS 2, BSS 3, and BSS 4.

Referring to FIG. 6, the APs may serve as be TWT scheduling APs in their respective BSSs. The APs participating in the TWT-based MAP coordination may directly exchange frames among the APs to negotiate the coordination.

In this disclosure, a TWT sharing AP may refer to an AP that has or intends to have an TWT schedule or an TWT agreement in its BSS and initiates a TWT coordination procedure with APs in the OBSS for better protection of the TWT SP, for example, to increase channel access opportunities or reduce OBSS interference. Additionally, a TWT shared AP may refer to an AP that receives the TWT coordination request from the TWT sharing AP. In an embodiment, a TWT sharing AP may share or propose TWT information of the STAs with TWT shared AP(s), which may be referred to as ‘coordinated TWT (C-TWT).’ This coordination may help in mitigating OBSS interference or enhancing signal power during TWT SP.

In the current TWT operation, there are no rules to terminate the TWT-based MAP coordination. Therefore, the present disclosure provides various concepts, conditions, and procedures for the TWT-based MAP coordination.

In some embodiments, when a TWT sharing AP intends to update the parameters for the C-TWT, these updates need to be conveyed to TWT shared APs and subsequently informed to the BSSs of the TWT shared APs.

In an embodiment, the TWT shared APs monitors beacon frames of the TWT sharing AP that announces any changes or upcoming updates to TWT parameters for the TWT-based MAP coordination or C-TWT schedule. Whenever the TWT sharing AP announces the updates to the TWT parameter for the TWT-based MAP coordination or the C-TWT schedule, the TWT shared APs accommodate the updates and subsequently notifies their respective BSSs. When the updates to the TWT parameters do not work for a TWT shared AP, or a TWT shared AP may not be able to accommodate the updates, the TWT shared AP may terminate the TWT-based MAP coordination and notify the termination to the TWT sharing AP. This may be an example of an implicit notification

In an embodiment, the TWT sharing AP may explicitly notify each of TWT shared APs about impending changes to the TWT parameters for the TWT-based MAP coordination or C-TWT schedule. The TWT shared APs may respond with acceptance, rejection, or suggest alternative suggestions. When the TWT shared APs accept the updates to the TWT parameters, they may subsequently notify their respective BSSs of the updates. When a TWT shared AP rejects the updates, the TWT-based MAP coordination may be terminated for the TWT shared AP, and the TWT shared AP may notify the termination to its BSS.

In an embodiment, either TWT sharing AP or TWT shared AP may terminate the TWT-based MAP coordination at any time, but they need to notify the other party of the termination.

The TWT sharing AP or TWT shared AP may send an individually addressed frame, a broadcast frame, or a multicast frame to indicate that it does not intend to participate in the TWT-based MAP coordination, and then it may terminate the TWT-based MAP coordination.

The termination procedures or conditions may apply for other types of multi-AP coordination including, for example and without limitation, joint transmission and coordinated beamforming.

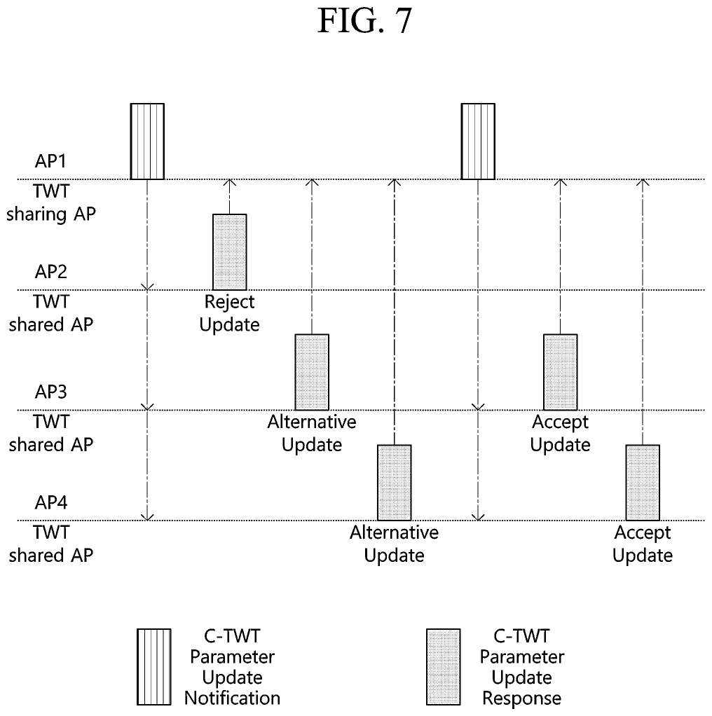

FIG. 7 shows an example of C-TWT parameter update negotiation in accordance with an embodiment. The operation depicted in FIG. 7 is for illustration purposes and does not limit the scope of this disclosure to any particular implementations.

In FIG. 7, AP 1 is a TWT sharing AP for TWT-based MAP coordination while AP 2, AP 2, and AP 3 are TWT shared APs for the TWT-based MAP coordination. AP 1 sends a C-TWT parameter update notification to AP 2, AP 3, and AP 4, indicating its intention to change or update the C-TWT parameters. The TWT parameter update notification may be transmitted through an individually addressed frame, a broadcast frame, or a multicast frame. In response, AP 2 rejects to comply with the updated C-TWT parameters by sending a C-TWT parameter update response to AP 1. Consequently, the TWT-based MAP coordination between AP 1 and AP 2 is terminated. On the other hand, AP 3 and AP 4 suggest alternative set of TWT parameters to the updates by sending C-TWT parameter update responses, respectively. Subsequently, AP 1 notifies new updates or changes to AP 3 and AP 4 by sending a second C-TWT parameter update notification. Both AP 3 and AP 4 accept the updates by sending C-TWT parameter update response, respectively.

In some embodiments, there may be different modes of MAP coordination termination. For example, a full MAP termination and a partial MAP termination. In this disclosure, the MAP coordination termination can be referred to as “MAP termination” for simplicity. In an embodiment of the full MAP termination, when a termination frame is transmitted to terminate a particular type of MAP coordination, all the existing agreements for the MAP coordination can be terminated. In an embodiment of the partial MAP termination, when a termination frame is transmitted to terminate a particular type of MAP coordination, only subset of existing agreements for the MAP coordination is terminated while the other part of agreement for the MAP coordination is not terminated and maintained.

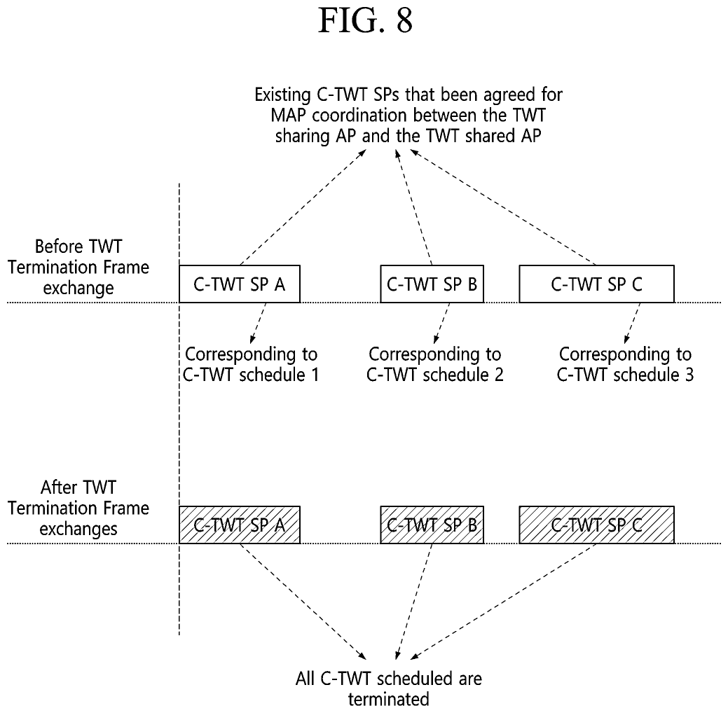

FIG. 8 shows an example of a full MAP termination in accordance with an embodiment. The operation depicted in FIG. 8 is for illustration purposes and does not limit the scope of this disclosure to any particular implementations.

The top line in FIG. 8 shows C-TWT SPs among a TWT sharing AP and one or more TWT shared APs in a TWT-based MAP coordination. As shown, three C-TWT SPs (C-TWT SP A, C-TWT SP B, and C-TWT SP C) have been agreed for the TWT-based MAP coordination. C-TWT SP A corresponds to C-TWT schedule 1 while C-TWT SP B and C-TWT SP C correspond to C-TWT schedule 2 and C-TWT schedule 3, respectively.

The bottom line in FIG. 8 illustrates the situation after the termination of TWT-based MAP coordination. As shown, all C-TWT SPs corresponding to C-TWT schedules 1-3 are terminated.

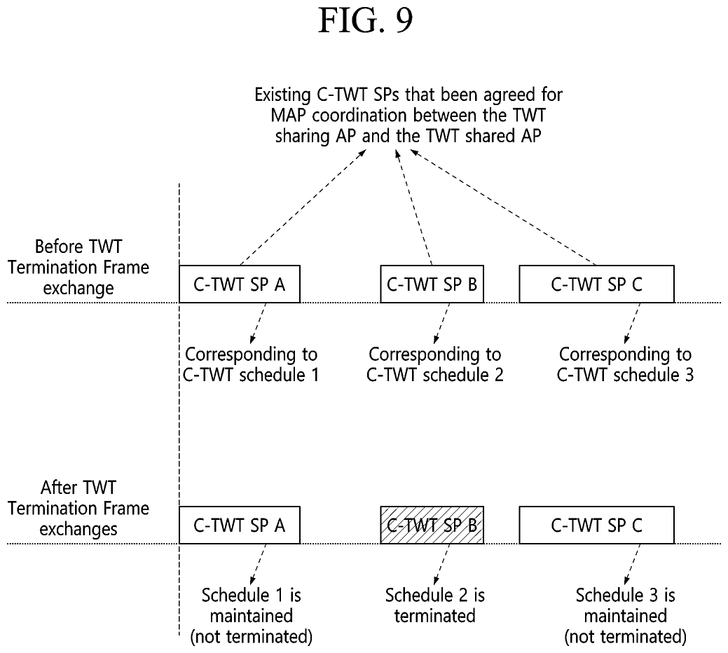

FIG. 9 shows an example of a partial MAP termination in accordance with an embodiment. The operation depicted in FIG. 9 is for illustration purposes and does not limit the scope of this disclosure to any particular implementations.

The top line in FIG. 9 shows C-TWT SPs among a TWT sharing AP and one or more TWT shared APs in a TWT-based MAP coordination. As shown, three C-TWT SPs (C-TWT SP A, C-TWT SP B, and C-TWT SP C) have been agreed for the TWT-based MAP coordination. C-TWT SP A corresponds to C-TWT schedule 1 while C-TWT SP B and C-TWT SP C correspond to C-TWT schedule 2 and C-TWT schedule 3, respectively.

The bottom line in FIG. 9 illustrates the situation after the partial termination of TWT-based MAP coordination. As shown, C-TWT SP B corresponding to C-TWT schedule 2 is terminated, while C-TWT SP A and C-TWT SP C are not terminated and maintained.

In some embodiments, a first AP has agreed to coordinate with a second AP for TWT-based MAP coordination and established a MAP coordination agreement. The first AP may send a MAP termination frame to the second AP indicating that the first AP intends to terminate one or more MAP agreements between the first AP and the second AP. Upon transmitting the MAP termination frame by the first AP, the intended MAP agreement(s) is terminated.

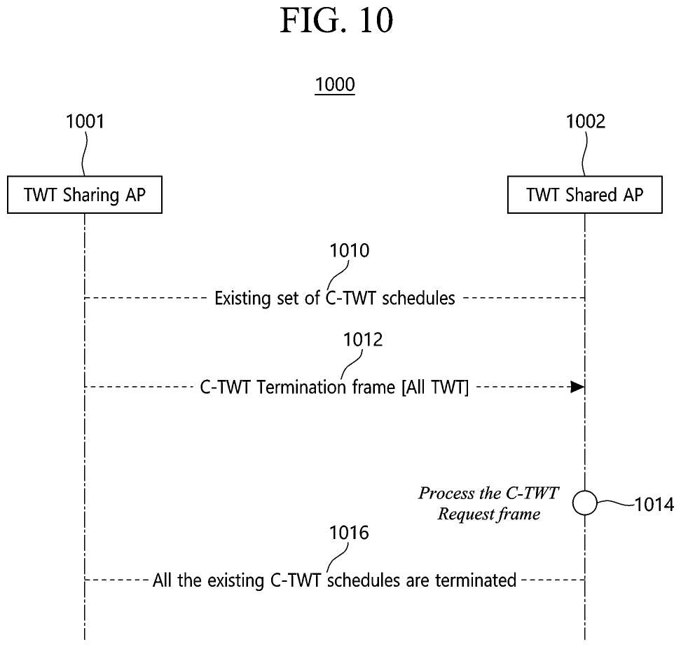

FIG. 10 shows an example process 1000 of MAP agreement termination in TWT-based MAP coordination in accordance with an embodiment. The scenario and operations depicted in FIG. 10 are also for illustration purposes and do not limit the scope of this disclosure to any particular implementations.

Referring to FIG. 10, the process 1000 may begin in operation 1010. In operation 1010, a TWT sharing AP 1001 establishes one or more C-TWT schedules for TWT-based MAP coordination with a TWT shared AP 1002.

In operation 1012, the TWT sharing AP 1001 intends to terminate all C-TWT schedules established with the TWT shared AP 1002. The TWT sharing AP 1001 transmits a C-TWT termination frame to the TWT shared AP 1002. The C-TWT termination frame indicates a full MAP termination.

In operation 1014, upon receiving the C-TWT termination frame from the TWT sharing AP 1001, the TWT shared AP 1002 processes the C-TWT termination frame.

In operation 1016, all the existing C-TWT schedules between TWT sharing AP 1001 and TWT shared AP 1002 are terminated.

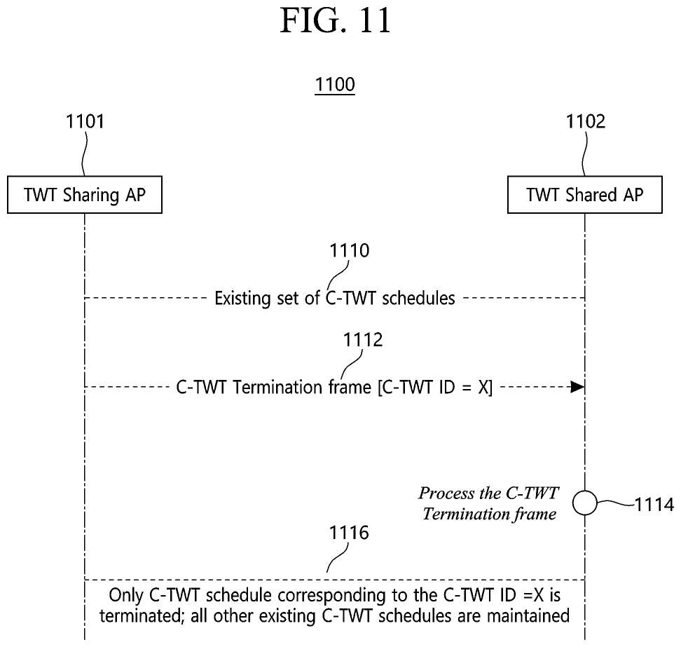

FIG. 11 shows another example process 1100 of MAP agreement termination in TWT-based MAP coordination in accordance with an embodiment. The scenario and operations depicted in FIG. 11 are also for illustration purposes and do not limit the scope of this disclosure to any particular implementations.

Referring to FIG. 11, the process 1100 may begin in operation 1110. In operation 1110, a TWT sharing AP 1101 establishes one or more C-TWT schedules for TWT-based MAP coordination with a TWT shared AP 1102.

In operation 1112, the TWT sharing AP 1101 intends to terminate only a subset of C-TWT schedules among all C-TWT schedules established with the TWT shared AP 1102. The TWT sharing AP 1101 transmits a C-TWT termination frame to the TWT shared AP 1102. The C-TWT termination frame indicates a partial MAP termination. In an embodiment, the C-TWT termination frame indicates that a C-TWT schedule with [C-TWT ID=X] is to be terminated.

In operation 1114, upon receiving the C-TWT termination frame from the TWT sharing AP 1101, the TWT shared AP 1102 processes the C-TWT termination frame.

In operation 1116, only C-TWT schedule corresponding to [C-TWT ID=X] is terminated, while all other existing C-TWT schedules are maintained.

In some embodiments, upon receiving the C-TWT termination frame from the TWT sharing AP 1101, the TWT shared AP 1102 may send an ACK frame to the TWT sharing AP 1101 as a response. Upon sending the ACK frame to the TWT sharing AP 1101, the intended C-TWT schedule can be terminated.

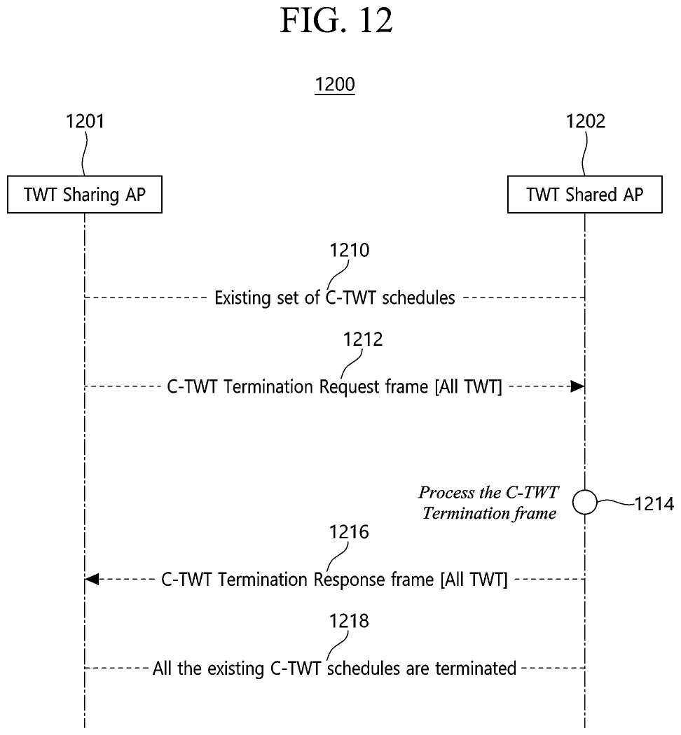

FIG. 12 shows another example process 1200 of MAP agreement termination in TWT-based MAP coordination in accordance with an embodiment. The scenario and operations depicted in FIG. 12 are also for illustration purposes and do not limit the scope of this disclosure to any particular implementations.

Referring to FIG. 12, the process 1200 may begin in operation 1210. In operation 1210, a TWT sharing AP 1201 establishes one or more C-TWT schedules for TWT-based MAP coordination with a TWT shared AP 1202.

In operation 1212, the TWT sharing AP 1201 intends to terminate all existing C-TWT schedules established with the TWT shared AP 1202. TWT sharing AP 1201 transmits a C-TWT termination frame to TWT shared AP 1202. The C-TWT termination frame indicates a full MAP termination.

In operation 1214, upon receiving the C-TWT termination frame from the TWT sharing AP 1201, the TWT shared AP 1202 processes the C-TWT termination frame.

In operation 1216, the TWT shared AP 1202 transmits a C-TWT termination response frame to the TWT sharing AP 1201. The C-TWT termination response frame can be an ACK frame.

In operation 1218, all the existing C-TWT schedules between TWT sharing AP 1201 and TWT shared AP 1202 are terminated.

In some embodiments, a first AP and a second AP have established one or more types of MAP coordination agreements, for example and without limitation, coordinated TWT (C-TWT), coordinated spatial reuse (C-SR), Coordinated Time division multiple access (C-TDMA), or coordinated beamforming (C-BF) or coordinated joint transmission (C-JT). The first AP may send a MAP termination frame to the second AP to terminate an existing MAP agreement. In the MAP termination frame, the first AP may indicate which type of MAP coordination agreement to be terminated. Furthermore, the first AP may also identify a subset of MAP coordination agreements, within the indicated type of MAP coordination, that the first AP intends to terminate by including indication for the agreement to be terminated in the MAP termination frame, for example and without limitation, a C-TDMA ID corresponding to a particular type of C-TDMA agreement.

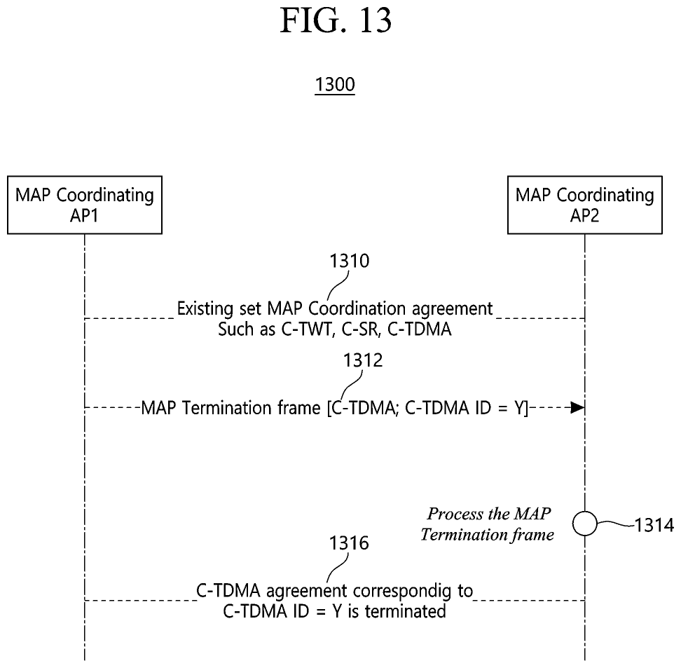

FIG. 13 shows an example process 1300 of MAP agreement termination among multiple types of MAP coordination in accordance with an embodiment. The scenario and operations depicted in FIG. 13 are also for illustration purposes and do not limit the scope of this disclosure to any particular implementations.

Referring to FIG. 13, the process 1300 may begin in operation 1310. In operation 1310, a MAP coordinating AP 1 establishes a set of MAP coordination agreements with a MAP coordinating AP 2.

In operation 1312, the MAP coordinating AP 1 intends to terminate only a subset of MAP coordination agreements among all the exiting MAP coordination agreements. The MAP coordinating AP 1 transmits a MAP termination frame to the MAP coordinating AP 2. The C-TWT termination frame indicates a type of MAP coordination and an identifier of an agreement to be terminated. In an embodiment, the C-TWT termination frame indicates that the C-TDMA agreement with [C-TDMA ID=Y] is to be terminated.

In operation 1314, upon receiving the MAP termination frame from the MAP coordinating AP 1, the MAP coordinating AP 2 processes the C-TWT termination frame.

In operation 1316, the C-TDMA agreement with [C-TDMA ID=Y] is terminated.

An example format of the MAP termination frame is shown in Table 1 below. In some embodiments, the same format may be used for a MAP termination request frame when request/response-based termination is required. The MAP termination frame may include a Category field, an Unprotected SIG Action field, a Dialog Token field, a MAP termination Mode field, a MAP Agreement Type field, and a MAP Agreement ID field. The Category field may indicate a category of the MAP termination frame. The Unprotected SIG Action field may include a field value associated with the MAP termination frame to differentiate the unprotected SIG action frame formats. The Dialog Token field may include a value to identify the MAP termination transaction. The MAP Termination Mode field may indicate whether a partial MAP termination or a full MAP termination is requested. In an embodiment, when the MAP Termination Mode field is set to 1, it may indicate that the full MAP termination is requested. Conversely, when the MAP Termination Mode field is set to 0, it may indicate the partial MAP termination is requested. The MAP Agreement Type field may indicate a type of MAP agreement to be terminated. In an embodiment, when the field is set to 0, it may indicate the termination of C-TWT. When the field is set to 1, it may indicate the termination of C-TDMA, and when the field is set to 2, it may indicate the termination of C-SR. The MAP Agreement ID field indicates an identifier for the MAP agreement to be terminated. The type of the MAP agreement is indicated in the MAP Agreement Type field.

TABLE 1

| Order | Information |
|---|---|
| 1 | Category |
| 2 | Unprotected S1G Action |
| 3 | Dialog Token |
| 4 | MAP Termination Mode |
| 5 | MAP Agreement Type |
| 6 | MAP Agreement ID |

An example format of a MAP termination response frame is shown in Table 2 below. The MAP termination response frame may include a Category field, an Unprotected SIG Action field, a Dialog Token field, a STATUS code field, a MAP termination Mode field, a MAP Agreement Type field, and a MAP Agreement ID field. The Category field may indicate a category of the MAP termination response frame. The Unprotected SIG Action field may include a field value associated with the MAP termination response frame to differentiate the unprotected SIG action frame formats. The Dialog Token field may include a value to identify the MAP termination transaction. The STATUS code field may indicate the success or failure of the requested operation. In an embodiment, when the code field is set to 0, it may indicate a rejection to the MAP termination request. When the code field is set to 1, it may indicate an acceptance to the MAP termination request, and when the code field is set to 2, it may indicate an alternative suggestion to the MAP termination request. The alternative suggestion may be indicated in the MAP termination Mode field, the MAP Agreement Type field, and the MAP Agreement ID field. The MAP Termination Mode field may indicate a partial MAP termination or a full MAP termination. In an embodiment, when the MAP Termination Mode field is set to 1, it may indicate the full MAP termination. Conversely, when the MAP Termination Mode field is set to 0, it may indicate the partial MAP termination. The MAP Agreement Type field may indicate the type of MAP agreement to be terminated. In an embodiment, when the field is set to 0, it may indicate the termination of C-TWT. When the field is set to 1, it may indicate the termination of C-TDMA, and when the field is set to 2, it may indicate the termination of C-SR. The MAP Agreement ID field indicates an identifier for the MAP agreement to be terminated. The type of the MAP agreement is indicated in the MAP Agreement Type field.

TABLE 2

| Order | Information |
|---|---|
| 1 | Category |
| 2 | Unprotected S1G Action |
| 3 | Dialog Token |
| 4 | STATUS Code |
| 5 | MAP Termination Mode |
| 6 | MAP Agreement Type |
| 7 | MAP Agreement ID |

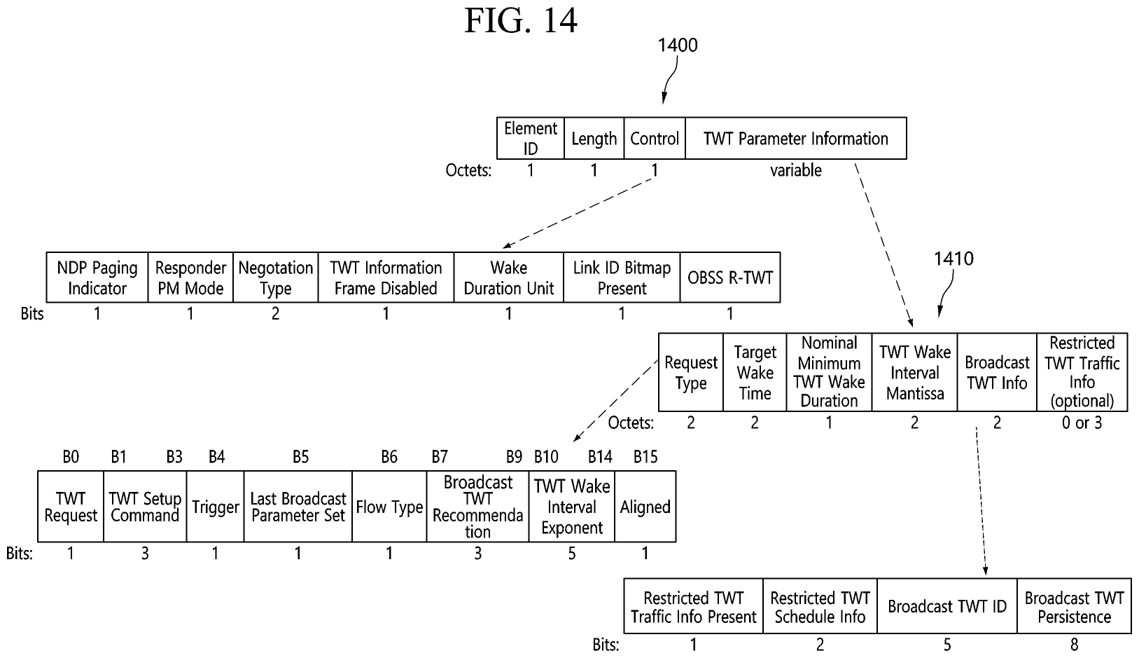

FIG. 14 shows an example format of the TWT element in accordance with an embodiment.

In FIG. 14, the TWT element 1400 may include an Element ID field, a length field, a Control field, and one or more a TWT Parameter Information field. The Element ID field may include information to identify the TWT element 1400. The Length field may indicate a length of the TWT element 1400.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field includes an individual TWT parameter set field or one or more Broadcast TWT Parameter Set fields. For the convenience of description, FIG. 14 illustrates the Broadcast TWT Parameter Set fields. The Broadcast TWT Parameter Set field 1410 may include a Request Type field, a Target Wake Time field, a Nominal Minimum TWT Wake Duration field, a TWT Wake Interval Mantissa field, a Broadcast TWT Info field, and an optional Restricted TWT traffic Info field.

The Request Type field of the Broadcast TWT Parameter Set field 1410 can be used to indicate the presence of the aligned TWT schedule. Referring to FIG. 14, the Request Type field includes a TWT Request subfield, a TWT Setup Command subfield, a Trigger subfield, a Last Broadcast Parameter Set subfield, a Flow Type subfield, a Broadcast TWT Recommendation subfield, a TWT Wake Interval Exponent subfield, and an Aligned subfield. The Request Type field may be usable for Broadcast TWT operation.

The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links.

The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a restricted TWT traffic info present field, a restricted TWT schedule info field, a Broadcast TWT ID field and a Broadcast TWT Persistence field. The restricted TWT traffic info present field indicates whether the restricted TWT traffic info field is present. The restricted TWT schedule info field indicates whether an active R-TWT schedule is active. The Broadcast TWT ID field indicates a specific broadcast TWT for which the transmitting STA is providing TWT parameters. The Broadcast TWT persistence field indicates the number of TBTTs during which the Broadcast TWT SPs corresponding to this broadcast TWT parameter set are present.

According to various embodiments, a mechanism to negotiate and coordinate between a TWT sharing AP and a TWT shared AP on a partial set of TWT parameters for TWT-based MAP coordination. Therefore, the TWT sharing AP can consider the TWT coordination negotiation successful for the partial agreement. It will improve the channel access opportunities for STAs and APs participating in the TWT-based MAP coordination.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, comprising:
a memory; and
a processor coupled to the memory, the processor configured to cause:
establishing multi-AP coordination with a second AP, the multi-AP coordination including a set of agreements established between the first AP and the second AP; and
transmitting, to the second AP, a first frame that requests to terminate one or more agreements established between the first AP and the second AP.

2. The first AP of claim 1, wherein the processor is further configured to cause:
receiving, from the second AP, a second frame indicating a response to the first frame, the second frame including a field indicating acceptance, rejection, or alternative suggestion to requested termination of at least one agreement between the first AP and the second AP.

3. The first AP of claim 2, wherein the first frame or the second frame includes a field indicating if a partial termination of the set of agreements is requested or a full termination of the set of agreements.

4. The first AP of claim 2, wherein the first frame or the second frame includes a field indicating a type of multi-AP coordination.

5. The first AP of claim 2, wherein the first frame or the second frame includes a field indicating an identifier of an agreement to be terminated.

6. The first AP of claim 1, wherein the multi-AP coordination is a target wake time (TWT) based multi-AP coordination.

7. The first AP of claim 3, wherein when the field indicates that the partial termination is requested, a subset of agreements requested by the first frame or the second frame is terminated.

8. A first access point (AP) in a wireless network, comprising:
a memory; and
a processor coupled to the memory, the processor configured to cause:
establishing multi-AP coordination with a second AP, the multi-AP coordination including a set of agreements established between the first AP and the second AP; and
receiving, from the second AP, a first frame that requests to terminate one or more agreements established between the first AP and the second AP.

9. The first AP of claim 8, wherein the processor is further configured to cause:
transmitting, to the second AP, a second frame indicating a response to the first frame, the second frame including a field indicating acceptance, rejection, or alternative suggestion to requested termination of at least one agreement between the first AP and the second AP.

10. The first AP of claim 9, wherein the first frame or the second frame includes a field indicating if a partial termination of the set of agreements is requested or a full termination of the set of agreements.

11. The first AP of claim 9, wherein the first frame or the second frame includes a field indicating a type of multi-AP coordination.

12. The first AP of claim 9, wherein the first frame or the second frame includes a field indicating an identifier of an agreement to be terminated.

13. The first AP of claim 8, wherein the multi-AP coordination is a target wake time (TWT) based multi-AP coordination.

14. The first AP of claim 10, wherein when the field indicates that the partial termination is requested, a subset of agreements requested by the first frame or the second frame is terminated.

15. A method performed by a first access point (AP) device in a wireless network, comprising:
establishing multi-AP coordination with a second AP, the multi-AP coordination including a set of agreements established between the first AP and the second AP; and
transmitting, to the second AP, a first frame that requests to terminate one or more agreements established between the first AP and the second AP.

16. The method of claim 15, further comprising:
receiving, from the second AP, a second frame indicating a response to the first frame, the second frame including a field indicating acceptance, rejection, or alternative suggestion to requested termination of at least one agreement between the first AP and the second AP.

17. The method of claim 16, wherein the first frame or the second frame includes a field indicating if a partial termination of the set of agreements is requested or a full termination of the set of agreements.

18. The method of claim 16, wherein the first frame or the second frame includes a field indicating a type of multi-AP coordination.

19. The method of claim 16, wherein the first frame or the second frame includes a field indicating an identifier of an agreement to be terminated.

20. The method of claim 17, wherein when the field indicates that the partial termination is requested, a subset of agreements requested by the first frame or the second frame is terminated.
